(19) United States
(12) Patent Application Publication
(10) Pub. No.: US 2019/0095999 A1
(43) Pub. Date: Mar. 28, 2019

(54) COGNITIVE AGENT ASSISTANT

(71) Applicant: ACCENTURE GLOBAL SOLUTIONS LIMITED, Dublin (IE)

(72) Inventors: Chung-Sheng LI, San Jose, CA (US); Guanglei Xiong, Pleasanton, CA (US); Madhura Shivaram, Bangalore (IN); Soujanya Soni, Bangalore (IN); Ashish Jain, Chennai (IN); Deepak Kumar Arjun, Chennai (IN); Sukryool Kang, Sunnyvale, CA (US); Rama Veeravalli Santhanam, Chennai (IN); Clark C. Valera, San Mateo (PH); Melchor F. Dela Cruz, Caloocan City (PH); Muthu Venkatesh Prabakaran, Chennai (IN); Krishna Kummamuru, Bangalore (IN); Joble George, Philadelphia, PA (US); Saurabh Mahadik, Mumbai (IN); Shikhar Vashishtha, Kharghar (IN); Mingzhu Lu, San Jose, CA (US); Sanjay Chamoli, Gurgaon (IN); Suraj G. Jadhav, Mumbai (IN); Lauren E. Friedman, Providence, RI (US)

(73) Assignee: ACCENTURE GLOBAL SOLUTIONS LIMITED, Dublin (IE)

(21) Appl. No.: 15/877,291

(22) Filed: Jan. 22, 2018

Related U.S. Application Data
(60) Provisional application No. 62/564,898, filed on Sep. 28, 2017.

(51) Int. Cl. G06Q 40/08; G06Q 10/10; G06K 9/62; G06N 5/02

(52) U.S. Cl. CPC G06Q 40/08; G06N 5/025; G06K 9/6278; G06Q 10/10

(57) ABSTRACT

A claims preprocessor processes claim data to identify claims that are to be adjudicated. Each claim includes at least one claim exception. The claims preprocessor further prioritizes the claim exception of each identified claim based on the claim data. A robotic process automator then orchestrates adjudication of the identified claims based on claim data. Further, a rules engine adjudicates the identified claims based on pre-defined rules. Subsequently, a fall out handler determines if any of the identified claims are incorrectly adjudicated and identify an issue associated with incorrect claims adjudication on determining that any of the identified claims are incorrectly adjudicated. A self learner then provides feedback to rules engine based on a decision tree and information received from fall out handler, the feedback being usable to resolve the issue. The information received from fall out handler is indicative of issue associated with incorrect claims adjudication.

This application claims priority from U.S. Provisional application No. 62/564,898 filed on Sep. 28, 2017, the disclosure of which is incorporated by reference in its entirety.

### BACKGROUND

Claims adjudication refers to a process of paying claims submitted by a person or denying them after comparing the claims with benefits and coverage details. Claims adjudication today is performed through a combination of automatic claims adjudication and manual claims adjudication. In automatic claims adjudication, a claim is adjudicated automatically without any manual or human intervention. The claim process that is done automatically is referred to as auto-adjudication.

Claims adjudication systems typically first attempt to adjudicate claims automatically. The claims that cannot be adjudicated automatically are sent for manual claims adjudication where the claims are processed manually. In an example, if the claims adjudication system is not able to take a decision on a claim, i.e., whether to pay or not to pay the claim, then the claim is sent for manual claims adjudication. There is however a need to reduce the amount of manual claims adjudication because such adjudication may be costly, time-consuming, and error prone in comparison to automatic claims adjudication. However, the claims adjudication systems that perform automatic claim adjudication are unable to account for exceptions in claims that then typically cause the claims to be adjudicated manually. This presents a technical problem of devising claims adjudication systems that can account for exceptions during the auto-adjudication process. The present disclosure is directed to technical solutions that may allow a claims adjudication system to account for exceptions in claim handling so as to automatically adjudicate claims. This may increase the efficiency of systems that auto-adjudicated claims.

### BRIEF DESCRIPTION OF DRAWINGS

Features of the present disclosure are illustrated by way of examples shown in the following figures. In the following figures, like numerals indicate like elements, in which:

FIG. 1 illustrates a network environment implementing a system, according to an example embodiment of the present disclosure;

FIG. 2 illustrates a block diagram of the system, according to an example embodiment of the present disclosure;

FIG. 3 illustrates an example claims adjudication process, according to an example embodiment of the present disclosure;

FIG. 4 illustrates a hardware platform for implementation of the system, according to an example embodiment of the present disclosure; and

FIG. 5 illustrates a computer-implemented method depicting functionality of the system, according to an example embodiment of the present disclosure.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent however, that the present disclosure may be practiced without limitation to all these details. Also, throughout the present disclosure, the terms “a” and “an” are intended to denote at least one of a particular element. As used herein, the term “includes” means includes but not limited to, the term “including” means including but not limited to. The term “based on” means based at least in part on.

The present subject matter describes systems and methods for adjudicating claims that were previously unable to be adjudicated by a machine. In an example embodiment of the present disclosure, the system may include a claims preprocessor, a robotic process automator, and a rules engine. The claims preprocessor, the robotic process automator, and the rules engine may be in communication with each other to perform the functionalities of the system.

Further, in an example embodiment, the system may be communicatively coupled to a claim database through one or more communication links. The claim database may store claim data. In an example, the claim data may be indicative of a list of solvable claim exceptions and information corresponding to each of a plurality of claims. Whenever claims are to be adjudicated, the system retrieves the claim data from the claim database.

For the purpose of adjudicating claims, the claims preprocessor of the system of the present subject matter may select claims from amongst the plurality of claims for automatic adjudication. The claims preprocessor processes the claim data to identify the claims that are to be adjudicated from amongst the plurality of claims. In an example, the claims preprocessor selects the claims based on the list of solvable claim exceptions. Each of the selected claims includes at least one claim exception. In an example, the claims preprocessor selects the claims by using a combination of hard coded rules and unsupervised machine learning techniques, such as clustering and anomaly detection techniques.

The claims preprocessor rejects the claims that cannot be handled by the rules engine. All claims that cannot be processed by the rules engine are sent over alternative adjudication techniques. The remaining claims are then examined for exceptions that can be solved by the claims preprocessor. In an example, the claims preprocessor handles the claims exception in order of priority by examining conditional probability so that resolving one claim exception may resolve one or more of the remaining claim exceptions. Accordingly, the claim exception that can resolve remaining claim exceptions is given higher priority in comparison to other claim exceptions.

In an example embodiment, data from third-party applications may be used to handle claims adjudication. Thus, after the claim data is processed by claims preprocessor, data from third-party application may be incorporated into the claim data for claims adjudication. In an example embodiment, data from the third-party application may be incorporated via Optical Character Recognition (OCR) techniques, Natural Language Processing (NPL) techniques, and other Information Extraction (IE) techniques so that this data is usable by the system.

After exception handling, the claims and the claim data may be sent to the rules engine via a robotic process automator. The robotic process automator is used to orchestrate the claim adjudication process. This may include, for example, scraping the data from multiple applications including client system, and executing actions according to responses from the rules engine. The rules engine may use a combination of Artificial Intelligence (AI) and machine learning techniques to adjudicate the claims automatically. In an example, the rules engine adjudicates the claims based on pre-defined rules.

The adjudicated claims may then be sent to an external system for final validation. Further, in an example embodiment, confidence scores and control claims with known correct decisions may be used to determine the accuracy of claims adjudicated by rules engine. Claims that fail final validation are analyzed for the reasons they were not adjudicated correctly. The results of the analysis are incorporate to formulate new rules and policies which are then integrated through self learning techniques and fed back to the rules engine in order to fine tune the automatic claim adjudication process.

The system of the present disclosure may offer time-effective and accurate claims adjudication. Further, because the system adjudicates claims that could not be adjudicated by a machine, the system maximizes the auto-adjudication coverage while reducing processing errors. Also, the amount of manual claims adjudication is significantly reduced. Therefore, the present subject matter may provide for economic, accurate, and time-effective claims adjudication.

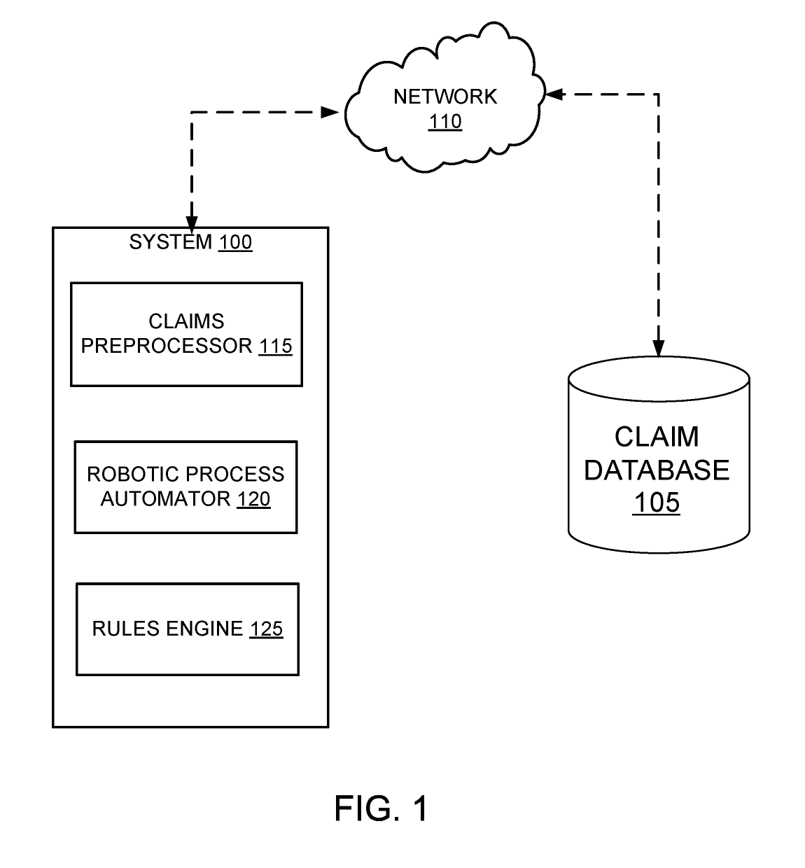

FIG. 1 illustrates a network environment implementing a system 100, according to an example embodiment of the present disclosure. The system 100 may also be referred to as a cognitive agent assistant. In an example embodiment, the system 100 continuously incorporates external inputs and also uses a combination of Artificial Intelligence (AI) and machine learning techniques to adjudicate claims that were previously unable to be adjudicated by a machine. The description hereinafter is explained with reference to healthcare claims only for the purpose of explanation and should not be construed as a limitation.

In an example embodiment, the network environment may be a public network environment, including thousands of individual computers, laptops, various servers, such as blade servers, and other computing devices. In another example embodiment, the network environment may be a private network environment with a limited number of computing devices, such as individual computers, servers, and laptops. Furthermore, the system 100 may be implemented in a variety of computing systems, such as a laptop, a tablet, and the like.

According to an example embodiment, the system 100 is communicatively coupled with a claim database 105 through a network 110. The claim database 105 may be a spatially indexed database that includes claim data. The claim data comprises information corresponding to various claims and a list of solvable claim exceptions. Each claim may include one or more claim exceptions. In an example, information corresponding to a claim may include, but is not limited to, patient identification information, a service date, a billing code, and a cost. The claim data may include any other suitable information related to the claims. Further, the list of solvable claim exceptions may be determined by the system 100 based on a statistical analysis of the exception combinations of the various claims and information corresponding to the claims.

In an example, the system 100 may retrieve data from a variety of sources, including third party sources such as policy databases, document repositories and other such information sources, data stores, and/or third party applications, and store the data as the claim data in the claim database 105 for future reference. Further, the claim database 105 may be accessed whenever claims are to be adjudicated by the system 100. Furthermore, the claim database 105 may be periodically updated. For example, new data may be added into the claim database 105, existing data in the claim database 105 may be modified, or non-useful data may be deleted from the claim database 105.

In an example embodiment, the network 110 may be a wireless network, a wired network, or a combination thereof. The network 110 may also be an individual network or a collection of many such individual networks, interconnected with each other and functioning as a single large network, e.g., the Internet or an intranet. The network 110 may be implemented as one of the different types of networks, such as intranet, local area network (LAN), wide area network (WAN), the internet, and the like. Further, the network 110 may include a variety of network devices, including routers, bridges, servers, computing devices, storage devices, and the like.

According to an example embodiment, the system 100 may include a claims preprocessor 115, a robotic process automator 120, and a rules engine 125. In an example embodiment, the claims preprocessor 115, the robotic process automator 120, and the rules engine 125 may be in communication with each other to perform the functionalities of the system 100.

In an example embodiment, a plurality of claims is initially fed into the claims preprocessor 115. A user of a healthcare enterprise may feed the plurality of claims. The claims preprocessor 115 performs an initial analysis of the claims and selects the claims from amongst the plurality of claims for automatic adjudication by the rules engine 125. The claims may be selected based on a list of solvable exceptions stored in the claim database 105. In an example, the claims preprocessor 115 may reject the claims that cannot be handled by the rules engine 125. Claims that are not selected for automatic adjudication are sent over alternative adjudication techniques. In addition, a claim may be rejected if it belongs to a known uncovered scenario. Further, a claim may also be rejected it belongs to an unknown uncovered scenario. All claims that cannot be processed by the rules engine 125 are sent over alternative adjudication techniques.

Once the claims that are to be adjudicated are identified, the robotic process automator 120 (or, alternatively, a business process manager (BPM) may orchestrate adjudication of the identified claims based on the claim data. In an example, the robotic process automator 120 orchestrates the adjudication of the claims for scraping the data from multiple applications including client system, and executing actions according to responses from the rules engine 125. Specifically, the robotic process automator 120 passes the scraped data gathered from various systems, formats it into a format readable by the rules engine 125, and sends the scraped data to the rules engine 125. Alternatively, the RPA or the BMP can read the data directly from the API of the system instead of scraping the data. In an example embodiment, the RPA may orchestrate at the presentation layer while the BPM may orchestrate at the API layer.

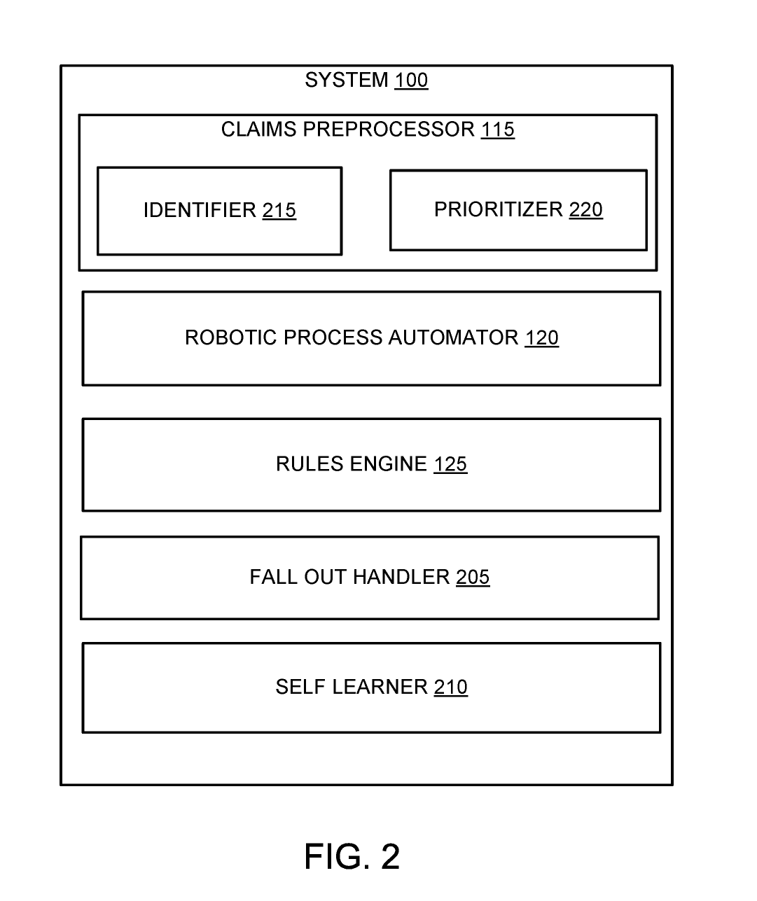

Subsequently, upon receiving the scraped data, the rules engine 125 may adjudicate the identified the claims based on pre-defined rules. A rule as used herein comprises a procedure for determining that a claim complies with pre-determined requirements. Examples of pre-determined requirements include, but are not limited to, reimbursement conditions, reimbursement constraints, and reimbursement computation procedures. A rule also may comprise a prescribed guide, a precept, or a model for how to present, conduct or regulate an action on a claim. In an example, based on the pre-defined rules, the rules engine 125 may qualify a claim as a duplicate claim. The manner in which system 100 performs claims adjudication is further described in detail in conjunction with FIG. 2.

FIG. 2 illustrates a block diagram of the system 100, according to an example embodiment of the present disclosure. As described above, the system 100 may include the claims preprocessor 115, the robotic process automator 120, and the rules engine 125. Further, in an example embodiment, the system 100 includes a fall out handler 205 and a self learner 210. In an example embodiment, the fall out handler 205 may be in communication with the rules engine 125, and the self learner 210 may be in communication with the fall out handler 205. Also, the claims preprocessor 115 may include an identifier 215 and a prioritizer 220. The identifier 215 and the prioritizer 220 may be in communication with each other.

In an example embodiment, the identifier 215 receives a plurality of claims. The claims may be fed into the identifier 215 by a user. The user may be an employee of a healthcare enterprise. On receiving the plurality of claims, the identifier 215 processes claim data to identify one or more claims that are to be adjudicated from amongst the plurality of claims. Each of the identified one or more claims includes at least one claim exception. As described earlier, the claim data is indicative of a list of solvable claim exceptions and information corresponding each of the plurality of claims. The identifier 215 selects those claims, which include similar or same claim exceptions as the claims exceptions that are included in the list of solvable claim exceptions. Accordingly, the identifier 215 selects those claims from amongst the plurality of claims, which can be handled by the system 100.

The identifier 215 classifies the claim data into at least one known uncovered scenario category. Further, the identifier 215 rejects claims from amongst the plurality of claims that belong to the at least one known uncovered scenario category. These may be claim types that are known to be unable to be adjudicated by a machine. The identifier 215 also rejects claims that belong to an unknown uncovered scenario. These may be claims that fall out of a distribution curve of the known uncovered scenario. In an example embodiment, the identifier 215 may use unsupervised machine learning techniques to build the distribution curve to determine such claims.

In addition, for a given claim, the identifier 215 may determine similar claims with exceptions recently identified by the identifier 215 and assign a similarity score to the claim. If the similarity score is found to be exceeding a pre-defined threshold, then the identifier 215 rejects the claims. In such a manner, the claims which may cause exceptions and errors in the later stages of claims adjudication are not processed.

Once the claims that are to be adjudicated are identified, the prioritizer 220 prioritizes the at least one claim exception of each of the identified one or more claims based on the claim data. The claim exceptions are prioritized according to an order of resolution of the claims exceptions. In an example, some claim exceptions may be in duplication. Further, in some claim exceptions, there may be information mismatch. The prioritizer 220 then decides whether to resolve duplication first or information mismatch first, and based on the decision, the prioritizer 220 prioritizes the claim exceptions. In an example, the prioritizer 220 applies Bayesian techniques on the claim data. The Bayesian techniques consider weighting between conditional probabilities and prior probabilities.

In an example embodiment, the prioritizer 220 estimates the conditional probabilities of a claim exception that will be resolved next, given a set of remaining claim exceptions. The prioritizer 220 estimates the conditional probability so that resolving one claim exception may resolve one or more of the remaining claim exceptions. In an example, for each claim exception, there may be 10 conditional probabilities. Further, the prioritizer 220 estimates prior probabilities of a claim exception that will be resolved next based on a relative importance of its corresponding group from amongst all groups of claim exceptions.

Upon prioritization of the identified claims, data is extracted for each of the identified claims. In an example, the system 100 uses several third-party applications for claim exceptions handling. In an example, approval of a claim may depend on non-digital and/or unstructured data in the third-party applications. The data may be extracted manually or semi-automatically in a separate process. The data is then incorporated into the claim data for adjudication. In an example, the data from the third-party applications may be incorporated via Optical Character Recognition (OCR) techniques for non-digital form of data, such as scanned documents or hand-written forms. For unstructured data, the data from the third-party applications may be incorporated via Natural Language Processing (NPL) techniques and other Information Extraction (IE) techniques so that this data is usable by the system 100. The unstructured data may be natural or template language, such as authorization notes. The NLP and IE techniques may be used to understand the notes and extract key information about the authorization, for example, procedure code, quantities, or dates, or the decision about the authorization, i.e., approval or denial. In an example, for each claim exception, a graphical user interface of the system 100 may be presented to an external system for entering data gathered from various third-party applications. The data extraction process is executed in continuous modes. In other words, the data extraction process begins for next claim automatically after finishing the current claim.

In an example embodiment, the robotic process automator 120 orchestrates adjudication of the identified one or more claims based on the claim data and the extracted data for each of the identified claims. The robotic process automator 120 orchestrates adjudication of the identified claims for scraping data from multiple applications, and executes actions according to responses from the rules engine 125. Specifically, the robotic process automator 120 passes the scraped data gathered from various systems, formats it into a format readable by rules engine 125 and sends the scraped data and the claim data to rules engine 125. In an example, the scraped data of a claim may include, but is not limited to, claim details, patient details, provider details, line-level procedures, historical claims, and reference data, i.e., coverage and benefit details. According to an example embodiment, the robotic process automator 120 may provide the scraped data to the rules engine 125 as Extensible Markup Language (XML) or JavaScript Object Notation (JSON) messages through restful Application Programming Interface (API).

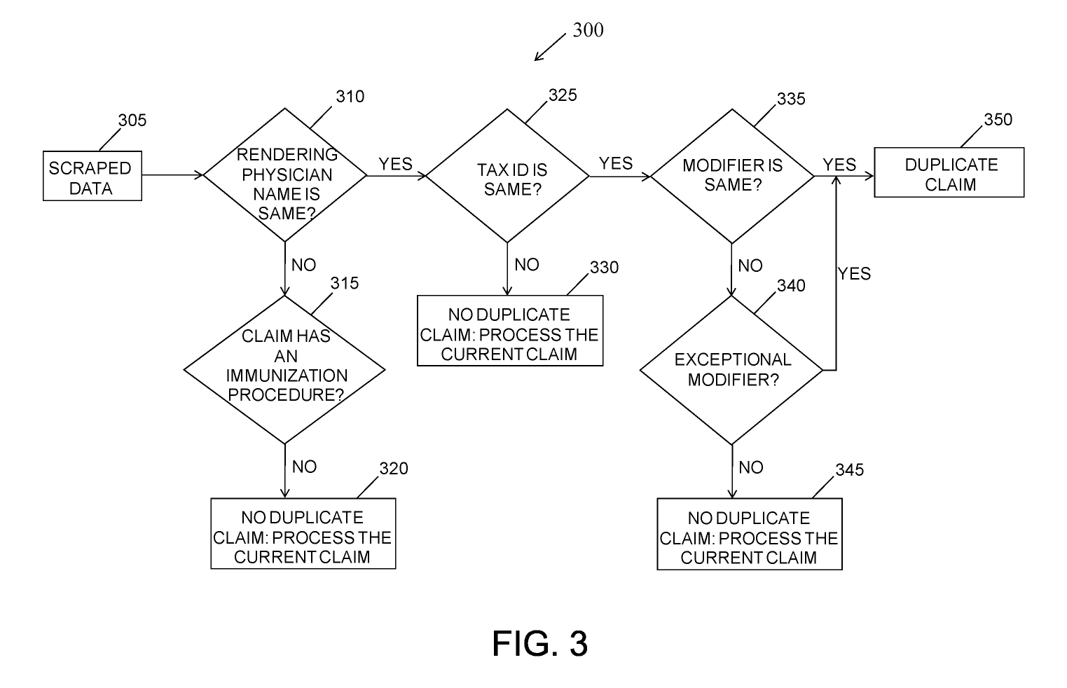

Subsequently, upon receiving the scraped data corresponding to the identified claims, the rules engine 125 adjudicates the identified one or more claims based on pre-defined rules. Further, the rules engine 125 sequentially resolves the claim exceptions of the claims based on priority associated with the claims exceptions. In an example, a rule as used herein may be understood as a procedure for determining that a claim complies with pre-determined requirements. Examples of pre-determined requirements include, but are not limited to, reimbursement conditions, reimbursement constraints, and reimbursement computation procedures. According to an example, a rule test condition may be used to adjudicate claims. The rule test condition may be simple or complex involving a combination of tests linked with conditions, for example, “Yes” or “No”. In an example, based on the pre-defined rules, the rules engine 125 may qualify a claim as a duplicate claim. An exemplary rule detects inconsistency between data fields of claims such as physician name, tax ID, etc. Alternatively, a rule may determine whether an amount mentioned in a claim exceeds a payer designated limit. The manner in which the rules engine 125 adjudicates the claims based on the pre-defined rules is further described in detail in conjunction with FIG. 3.

Once the claims are adjudicated by the rules engine 125, the adjudicated claims may be sent to an external system for final validation in order to ensure accurate claims adjudication. The validation may occur at other systems. According to said example, when accuracy reaches a certain level, the external system may start to validate only those claims that are associated with low level of confidence score. The accuracy may be estimated based on two ways. First way being, dividing a number of correctly processed claims by the rules engine 125 in production by a total number of processed claims. Further, the second way being, by using control claims with known correct decisions.

According to an example embodiment, confidence scores of the claims may be estimated based on machine learning. For example, historical claims that pass through the rules engine 125 are collected and all the rules during claims exception handling are recorded. Further, a regression model is learnt to map a set of rules to error rate calculated by counting the correct and incorrect historical claims. For a new claim, a determination is made as to which set of rules are fired and the regression model is used to estimate the confidence scores. Furthermore, the historical claims are updated when new rules are added and confidence scores estimation is re-trained. Claims that fail final validation are analyzed for the reasons they were not adjudicated correctly.

According to an example embodiment, the fall out handler 205 may determine if any of the identified one or more claims are incorrectly adjudicated. On determining that any of the identified one or more claims are incorrectly adjudicated, the fall out handler 205 may identify a cause for incorrect claims adjudication or an issue associated with incorrect claims adjudication. Examples of the issue associated with a claim may include an uncovered scenario in the rules engine 125 and undiscovered deficiency in the claim. Further, in an example, an associated with a claim may be that the claim has been paid to the wrong payee, or the claim paid is an underpayment and/or an overpayment. With appropriate labeling or correction from the external system, such cases are used to revising existing pre-defined rules in the rules engine 125 or discovering new rules through self-learning.

Thereafter, the fall out handler 205 may provide information is indicative of the issue associated with the incorrect claims adjudication to the self learner 210. The self learner 210 may generate a feedback based on the issue and provide the feedback to the rules engine 125. The feedback may be usable to resolve the issue associated with the incorrect claims adjudication. In an example, the self learner 210 may generate the feedback using a decision tree. The decision tree may be a data structure of nodes comprising correction rules for the identified one or more claims that are incorrectly adjudicated. The rules in the decision tree may be generated by traversing the decision tree from a root node to a leaf node. Such rules may be used in revising existing rules or serving as new rules after being confirmed by the external system. In an example, the decision tree is built from a dataset with feature vectors with associated decision labels. According to an example embodiment, the rules engine 125 may resolve the issue associated with the incorrect claims adjudication based on the revised or the new rules.

In the present disclosure, the system 100 attempts to maximizing claims auto-adjudication coverage while reducing processing errors by automatically adjudicating the claims that could not be previously adjudicated by a machine. Further, the system 100 seamlessly integrates the robotic process automator 120 and AI-empowered rules engine 125. The system 100 combines functionality of the robotic process automator 120 for data scraping and rules engine 125 for decision making. Specifically, the system 100 includes the robotic process automator 120 for orchestrating the client system and rules engine 125 for sequentially resolving the claim exceptions. The decision making is designed to be self-explainable and self-learnable though backward chaining and continuous learning. Thus, the process of claims adjudication is performed by the system 100 in an efficient, a time-effective, a cost-effective, and an accurate manner.

FIG. 3 illustrates an example claims adjudication process, according to an example embodiment of the present disclosure.

As can be seen in FIG. 3, block 305 represents scraped data corresponding to an identified claim that is received by the rules engine 125 from the robotic process automator 120. Further, at block 310, the rules engine 125 determines whether rendering physician name is same as other claims. If it determined that the rendering physician name is not same, then at block 315, the rules engine 125 determines if the claim has an immunization procedure. If it is determined that the claim does not have an immunization procedure, then at block 320, the rules engine 125 determines that the claim is not a duplicate claim and processes the claim.

Further, if it is determined that the rendering physician name is same as other claims or the claim has an immunization procedure, then the claim may be a duplicate claim. To verify that the claim is not a duplicate claim, other fields or data related to the claim may be examined. For example, at block 325, the rules engine 125 determines if the tax ID of the claim is same as the other claims. If it is determined that the tax ID is not same, then at block 330, the rules engine 125 determines that the claim is not a duplicate claim and processes the claim. Otherwise, if it is determined that the tax ID is same, the rules engine 125 moves to block 335. At block 335, the rules engine 125 determines if the claim modifier is same as other claims. If it is determined that the claim modifier is not same as other claims, then at block 340, the rules engine 125 determined if the modifier is an exceptional case. On determining the modifier to be an exceptional case, at block 345, the rules engine 125 determines that the claim is not a duplicate claim and processes the claim. Further, on determining the claim modifier to be same as other claims or on determining the modifier to be an exceptional case, then at block 350, the rules engines 125 qualifies the claim as a duplicate claim and does not process it.

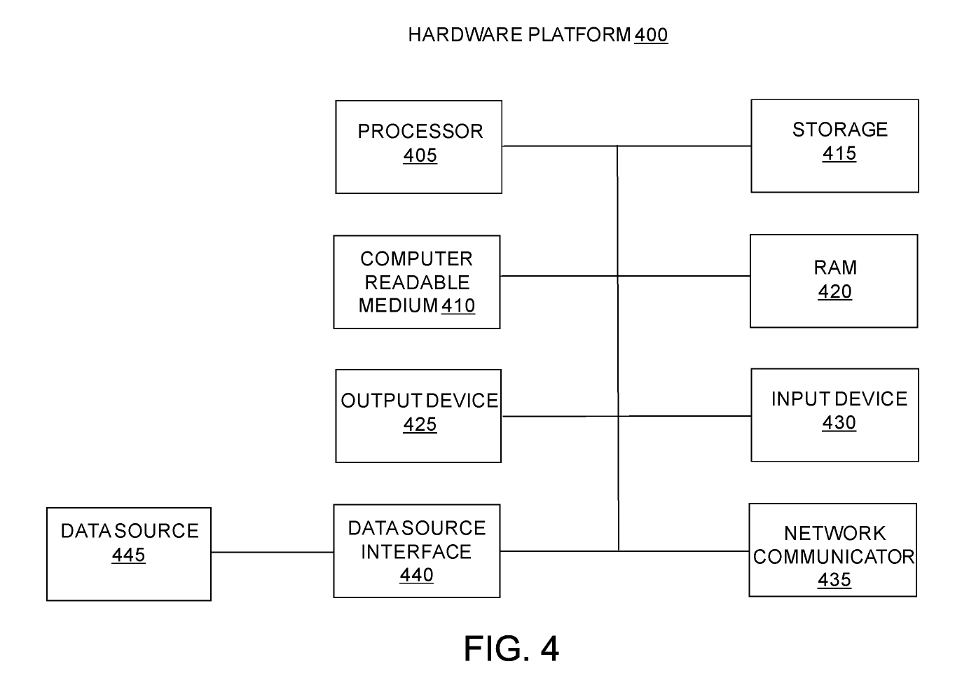

FIG. 4 illustrates a hardware platform 400 for implementation of the system 100, according to an example of the present disclosure. In an example embodiment, the hardware platform 400 may be a computer system 400 that may be used with the examples described herein. The computer system 400 may represent a computational platform that includes components that may be in a server or another computer system. The computer system 400 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory). The computer system 400 may include a processor 405 that executes software instructions or code stored on a non-transitory computer readable storage medium 410 to perform methods of the present disclosure. The software code includes, for example, instructions to preprocess the claims, resolve exceptions, incorporate third party data, adjudicate the claims, and validate the adjudication. In an embodiment, the rules engine 125 is a software code or a component performing the above steps.

The instructions on the computer readable storage medium 410 are read and stored the instructions in storage 415 or in random access memory (RAM) 420. The storage 415 provides a large space for keeping static data where at least some instructions could be stored for later execution. The stored instructions may be further compiled to generate other representations of the instructions and dynamically stored in the RAM 420. The processor 405 reads instructions from the RAM 420 and performs actions as instructed.

The computer system 400 further includes an output device 425 to provide at least some of the results of the execution as output including, but not limited to, visual information to users. The output device can include a display on computing devices. For example, the display can be a mobile phone screen or a laptop screen. GUIs and/or text are presented as an output on the display screen. The computer system 400 further includes input device 430 to provide a user or another device with mechanisms for entering data and/or otherwise interact with the computer system 400. The input device may include, for example, a keyboard, a keypad, a mouse, or a touchscreen. In an embodiment, claims adjudication results from the rules engine 125 are displayed on the output device 425. Each of these output devices 425 and input devices 430 could be joined by one or more additional peripherals.

A network communicator 435 may be provided to connect the computer system 400 to a network and in turn to other devices connected to the network including other clients, servers, data stores, and interfaces, for instance. A network communicator 435 may include, for example, a network adapter such as a LAN adapter or a wireless adapter. The computer system 400 includes a data source interface 440 to access data source 445. A data source is an information resource. As an example, a database of exceptions and rules may be a data source. Furthermore, knowledge repositories and curated data may be other examples of data sources.

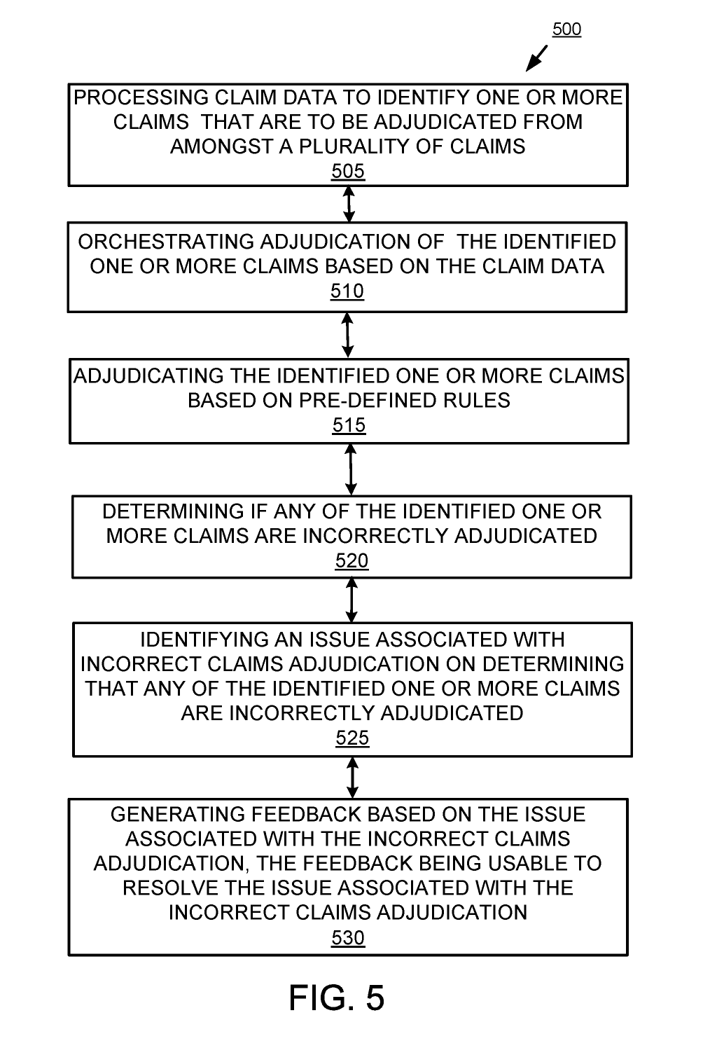

FIG. 5 illustrates a computer-implemented method 500 depicting functionality of the system 100, according to an example embodiment of the present disclosure. For the sake of brevity, construction and operational features of the system 100 which are explained in detail in the description of FIG. 1, FIG. 2, FIG. 3, and FIG. 4 are not explained in detail in the description of FIG. 5.

At method block 505, the method 500 commences with processing claim data to identify one or more claims that are to be adjudicated from amongst a plurality of claims. Each of the identified one or more claims includes at least one claim exception. In an example, the claim data is indicative of a list of solvable claim exceptions and information corresponding to each of the plurality of claims. The claims are selected based on the list of solvable exceptions. In an example embodiment, the identifier 215 of the system 100 processes the claim data to identify one or more claims that are to be adjudicated from amongst the plurality of claims.

At method block 510, adjudication of the identified one or more claims is orchestrated based on the claim data. The identified claims are adjudicated for scraping data from multiple applications. In an example, the scraped data of a claim may include, but is not limited to, claim details, patient details, provider details, line-level procedures, historical claims, and reference data, i.e., coverage and benefit details. The scraped data is provided to the rules engine 125 as Extensible Markup Language (XML) or JavaScript Object Notation (JSON) messages through restful Application Programming Interface (API). According to the example embodiment, the robotic process automator 120 of the system 100 orchestrates adjudication of the identified one or more claims based on the claim data.

At method block 515, the identified one or more claims are adjudicated based on pre-defined rules. According to the example embodiment, the rules engine 125 of the system 100 adjudicated the identified one or more claims.

At method 520, it is determined if any of the identified one or more claims are incorrectly adjudicated. According to example embodiment, the fall out handler 205 of the system 100 may determine if any of the identified one or more claims are incorrectly adjudicated.

At method block 525, an issue associated with incorrect claims adjudication is identified on determining that any of the identified one or more claims are incorrectly adjudicated. In an example embodiment, on determining that any of the identified one or more claims are incorrectly adjudicated, the fall out handler 205 may identify the issue associated with incorrect claims adjudication. Examples of the issue associated with a claim may include an uncovered scenario in the rules engine 125 and undiscovered deficiency in the claim.

At method block 530, feedback is generated based on the issue associated with the incorrect claims adjudication, the feedback being usable to resolve the issue associated with the incorrect claims adjudication. According to an example embodiment, the self learner 210 of the system 100 may generate the feedback based on the issue and provide the feedback to the rules engine 125 to resolve the issue.

What has been described and illustrated herein are examples of the present disclosure. The terms, descriptions and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

What is claimed is:

1. A system comprising:
a claims preprocessor, the claims preprocessor comprising:
an identifier to process claim data to identify one or more claims that are to be adjudicated from amongst a plurality of claims, wherein each of the identified one or more claims includes at least one claim exception; and
a prioritizer to prioritize the at least one claim exception of each of the identified one or more claims based on the claim data;
a robotic process automator, in communication with the claims preprocessor, the robotic process automator to orchestrate adjudication of the identified one or more claims based on the claim data;
a rules engine, in communication with the robotic process automator, the rules engine to adjudicate the identified one or more claims based on pre-defined rules;
a fall out handler, in communication with the rules engine, the fall out handler to:
determine if any of the identified one or more claims are incorrectly adjudicated; and
identify an issue associated with incorrect claims adjudication on determining that any of the identified one or more claims are incorrectly adjudicated; and
a self learner, in communication with the fall out handler and the rules engine, the self learner to provide feedback to the rules engine based on a decision tree and information received from the fall out handler, the feedback being usable to resolve the issue associated with the incorrect claims adjudication, wherein the information received from the fall out handler is indicative of the issue associated with the incorrect claims adjudication.

2. The system of claim 1, wherein the claim data is indicative of a list of solvable claim exceptions and information corresponding to each of the plurality of claims.

3. The system of claim 1, wherein the identifier further is to:
classify the claim data into at least one known uncovered scenario category; and
reject claims from amongst the plurality of claims that belong to the at least one known uncovered scenario category.

4. The system of claim 3, wherein the identifier further is to reject claims from amongst the plurality of claims that belong to an unknown uncovered scenario.

5. The system of claim 1, wherein the prioritizer prioritizes the at least one claim exception of each of the identified one or more claims using a Bayesian technique.

6. The system of claim 1, wherein the decision tree is a data structure comprising correction rules for the identified one or more claims that are incorrectly adjudicated.

7. A system comprising:
a claims preprocessor, the claims preprocessor comprising:
an identifier to process claim data to identify one or more claims that are to be adjudicated from amongst a plurality of claims;
a robotic process automator, in communication with the claims preprocessor, the robotic process automator to orchestrate adjudication of the identified one or more claims based on the claim data;
a rules engine, in communication with the robotic process automator, the rules engine to adjudicate the identified one or more claims based on pre-defined rules; and
a fall out handler, in communication with the rules engine, the fall out handler to:
determine if any of the identified one or more claims are incorrectly adjudicated; and
identify an issue associated with incorrect claims adjudication on determining that any of the identified one or more claims are incorrectly adjudicated; and
a self learner, in communication with the fall out handler and the rules engine, the self learner to provide feedback to the rules engine based on information received from the fall out handler, the feedback being usable to resolve the issue associated with the incorrect claims adjudication, wherein the information received from the fall out handler is indicative of the issue associated with the incorrect claims adjudication.

8. The system of claim 7, wherein the claims preprocessor processes the claim data using an unsupervised machine learning technique.

9. The system of claim 7, wherein the claim data is indicative of a list of solvable claim exceptions and information corresponding to each of the plurality of claims.

10. The system of claim 7, wherein each of the identified one or more claims includes at least one claim exception.

11. The system of claim 10, the claims preprocessor further comprising a prioritizer to prioritize the at least one claim exception of each of the identified one or more claims based on the claim data.

12. The system of claim 7, wherein the self learner provides the feedback to the rules engine based on a decision tree, and wherein the decision tree is a data structure comprising correction rules for the identified one or more claims that are incorrectly adjudicated.

13. A computer-implemented method, executed by at least one processor, the method comprising:
processing claim data to identify one or more claims that are to be adjudicated from amongst a plurality of claims;
orchestrating adjudication of the identified one or more claims based on the claim data;
adjudicating the identified one or more claims based on pre-defined rules;
determining if any of the identified one or more claims are incorrectly adjudicated;
identifying an issue associated with incorrect claims adjudication on determining that any of the identified one or more claims are incorrectly adjudicated; and
generating feedback based on the issue associated with the incorrect claims adjudication, the feedback being usable to resolve the issue associated with the incorrect claims adjudication.

14. The computer-implemented method of claim 13, wherein the claim data is indicative of a list of solvable claim exceptions and information corresponding to each of the plurality of claims.

15. The computer-implemented method of claim 13, the method further comprising:
classifying the claim data into at least one known uncovered scenario category; and
rejecting claims from amongst the plurality of claims that belong to the at least one known uncovered scenario category.

16. The computer-implemented method of claim 15, the method further comprising rejecting claims from amongst the plurality of claims that belong to an unknown uncovered scenario.

17. The computer-implemented method of claim 13, wherein each of the identified one or more claims includes at least one claim exception.

18. The computer-implemented method of claim 17, the method further comprising prioritizing the at least one claim exception of each of the identified one or more claims based on the claim data.

19. The computer-implemented method of claim 13, wherein the feedback is generated based on a decision tree, and wherein the decision tree is a data structure comprising correction rules for the identified one or more claims that are incorrectly adjudicated.

20. The computer-implemented method of claim 13, wherein the claim data is processed using an unsupervised machine learning technique.
